(19) United States
(12) Patent Application Publication
(10) Pub. No.: US 2016/0245368 A1
(43) Pub. Date: Aug. 25, 2016

(54) A BACKLASH-FREE PLANETARY GEAR ASSEMBLY

(71) Applicant: FAULHABER MINIMOTOR SA, Croglio (CH)

(72) Inventors: MANZOTTI RUGGERO, CASTELLO CABIAGLIO (IT); Rolando Berta, Bioggio (CH)

(21) Appl. No.: 14/901,329

(22) PCT Filed: Jun. 28, 2013
(86) PCT No.: PCT/EP2013/063677

§ 371 Date: Dec. 28, 2015

(51) Int. Cl. F16H 1/28; F16H 37/04; F16H 3/54; F16H 57/08

(52) U.S. Cl. CPC F16H 1/2863; F16H 57/082; F16H 37/04; F16H 3/54

(57) ABSTRACT

A planetary gear assembly including a first planet carrier member (4) and a second planet carrier member (5) which are rotatable relative to each other, and also comprising elastic connection means to provide a preload between said first and second planet carrier members, wherein said elastic connection means include an elastic member (11) associated to one (4) of said first and second planet carrier members, and a pin (12) protruding from the other (5) of said first and second planet carrier members, and upon a rotation between the carrier members (4, 5), said pin (12) abuts against the elastic member (11) and causes a deflection of said elastic member (11).

### FIELD OF THE INVENTION

The invention relates to the field of planetary and hybrid gearings. The invention discloses a reduced backlash planetary gear and relates also to a gear reducer or multiplier comprising said reduced backlash planetary gear.

### PRIOR ART

A planetary gear comprises one or more planet gears mounted on a planet carrier. The planet gears usually mesh with a sun gear and with an outer ring or annulus. The planet carrier rotates relative to the sun gear so that the planet gears revolve around said sun gear.

The planetary gear is a well known kind of epicyclic gear and has several advantageous features, including a notable transmission ratio in a compact package. Planetary gears are widely used for example in gear reducers coupled with electric motors. Higher reduction can be reached by multi-stage reducers comprising several planetary stages, or hybrid reducers comprising one or more conventional non-epicylic stages (e.g. spur stages) with one or more planetary stages.

Like any gear assembly, a planetary gear is affected by some clearance (or play) between the gears, which is also termed backlash. A planetary stage in particular is affected by backlash between the planet gears and the sun gear and/or annulus. Reduction of said backlash is desirable, especially when the planetary gear operate in both directions of rotation, since any clearance/play between the gear wheels generates an idle angle of rotation every time the rotation is reversed. This idle rotation may affect the precision of a servomotor unit including the planetary gear, for example.

Many attempts have been made to minimize the backlash and obtain reduced backlash planetary gear units. A planetary gear with a reduced backlash is also termed a “backlash-free” planetary gear.

WO 2009/106222 discloses a planetary gear unit where each planet gear is divided into a first planet subgear and a second planet subgear, and where the first planet subgear is preloaded relative to the second planet subgear by a spring bar.

WO 2010/132912 discloses a planetary gear wherein the planet wheels are elastically mounted on the planet carrier independently of each other.

A drawback of these systems is the complex design of the planet wheels.

It has also been proposed to provide a planet carrier comprising separate members which are elastically connected to provide a desired preload.

JP-3-48045 for example discloses to prevent the change of characteristics when a rotation direction is changed, by providing two floating carriers energized by compression springs.

All the above system have the drawback of a certain cost. They may be difficult and/or expensive to implement especially in miniaturized components. Furthermore, the desired preload may vary according to some conditions such as materials and the intended use (speed, torque, etc.). The above systems of the prior art do not provide a satisfactory solution to the above needs.

### SUMMARY OF THE INVENTION

The aim of the invention is to improve the above described prior art. In particular, a purpose of the invention is to provide a system for the backlash recovery in a planetary gear, which is simple, easy to manufacture and easy to assemble, and may be configure according to different specification, e.g. requiring a different preload.

The above purpose is reached with:

a planetary gear assembly, comprising a planet carrier including at least a first planet carrier member and a second planet carrier member which are rotatable relative to each other, and also comprising elastic connection means between said first and second planet carrier members, arranged to provide a preload when said planet carrier members are rotationally aligned in a design operation condition, characterized in that said elastic connection means include:

at least one elastic member associated to one of said first and second planet carrier members,

a protrusion associated to the other of said first and second planet carrier members, and engaging said elastic member,

said elastic member and said protrusion being arranged in such a way that a deflection of said elastic member provide said preload.

The term of deflection shall be understood in the sense that the elastic member bends substantially like a beam.

The protrusion may engage the elastic member in different manners. Preferably, the protrusion abuts against the elastic member, more preferably against a central portion of said elastic member.

Said elastic member is received in a suitable seat of the respective member of the planet carrier. Preferably, said seat is a slot with end parts configured to receive opposite ends of said elastic member, and a larger central portion to accommodate said protrusion and provide sufficient room for the deflection of the elastic member. Hence, upon a suitable rotation between the carrier members, the elastic member acts substantially as a centrally loaded beam

In some embodiments, a plurality of elastic members may be adopted. Elastic members may be housed in one or more planet carrier members. Generally speaking, an elastic member housed in a member of the planet carrier is engaged by a protrusion fixed to another member of the same planet carrier. According to a preferred embodiment, one of said planet carrier members is designed to house all the elastic members. In a preferred embodiment, four elastic members are used.

Said elastic member has preferably the form of a substantially laminar element, more preferably a flexible blade having a suitable thickness and flexibility. A flexible blade forming the elastic member may have a constant or a variable thickness. Preferably said flexible blade has a constant thickness and a rectangular cross section. The protrusion is preferably in the form of a pin, e.g. a cylindrical pin.

The main advantage is the easy implementation also at an industrial level. The elastic member, for example in the form of a flexible blade, is inexpensive and easy to mount in the carrier member. The related mounting seat does not require a precise and expensive machining. Also the matching with the protrusion from the other carrier member does not require a high precision.

The elastic constant of the system can be varied by replacing the elastic member with another one, according to a desired amount of the preload. Hence, a planet carrier for a planetary gear assembly can be configured according to different versions having a different preload, by using the same design of the carrier and just using different elastic members, e.g. different flexible blades, inserted in the mounting seats.

Compared e.g. to a system with a coil spring, requiring a corresponding cylindrical housing, the system of the invention is less expensive and is more configurable.

The above advantages are of particular importance for a manufacturer of planetary gear stages. They are important, in particular, for the making of small planetary stages, e.g. having a diameter of less than 10 mm, which are required in many fields including medical devices, robotics, aerospace industry, audio-video equipment and others. In these fields, a high precision is also requested and then the elimination of backlash becomes crucial.

Additional preferred features of the invention are as follows.

The planetary gear assembly normally comprise some planet wheels and a sun gear. The planet wheels are typically engaged with a ring gear housing (annulus). In a multi-stage reducer the sun gear of one stage is integral with the planet carrier of the consecutive stage, and mounted opposite to the planet wheels, to engage the planet wheels of another adjoining planetary stage.

The planet carrier is split into two or more elastically connected members. An assembly with two elastically connected planet carrier members optimizes the backlash of the planet wheels versus the ring gear housing; an assembly with three (or more) members can also reduce the backlash of the planet wheels versus the sun gear.

According to some embodiments of the invention, the sun gear of the inventive assembly is split into at least two axial portions which are rotatably relative to each other and fixed to respective planet carrier members.

For example said sun gear comprises a first axial portion and a second axial portion, which are rotatable relative to each other around said central axis; a first axial portion of the sun gear is fixed to a first planet carrier member, and a second axial portion of the sun gear is fixed to a second planet carrier member. In further embodiments, the sun gear may comprise more than two portions, each portion being fixed to a respective planet carrier member.

In a preferred embodiment, axial portions of the sun gear are mounted on coaxial shafts, for example a first hollow shaft and a second shaft coaxial to the first one. The first shaft is connected to a first planet carrier member, and the second shaft is connected to a second planet carrier member. Hence the above described elastic connection between planet carrier members provides a preload between said portions of the sun gear.

These embodiments result in the sun gear having two (or more) elastically preloaded axial portions. A sun gear with such elastically preloaded portions recovers the backlash relative to the planet wheels.

Preferably, the planet carrier members are in the form of substantially disc-like superimposed elements.

The planet carrier members and the planet gears can be made with known materials including metals and plastics. The flexible blade can be made of metal, a synthetic elastic material or another suitable material.

The invention can be embodied in a gear reducer or multiplier. Said gear reducer or multiplier can be a multi-stage unit, or a hybrid reducer/multiplier comprising one or more planetary stage(s) and one or more conventional non-epicyclic spur stage(s). A gear reducer is understood as a gear that can be used to reduce a transmission ratio, also called reducer. A gear multiplier is understood as a gear that can be used to multiply a transmission ratio, also called multiplier.

In some embodiments, only one planetary stage of a multi-stage unit may include the above described preloaded planet carrier members, which means that this particular stage, which can be termed a backlash-recovery stage, will compensate for the backlash of the device. In other embodiments, a plurality of stages or even all planetary stages may feature the preloaded carrier members of the invention.

Other advantages of the invention include: the planet wheels are conventional and inexpensive; the backlash generated by progressive wear of teeth is steadily compensated, while keeping the noise at the original level and maintaining the original specifications of the product.

These and other features and advantages of the invention shall become clearer from the following detailed description and with the help of the attached figures.

### DESCRIPTION OF THE FIGURES

FIG. 1 is a scheme of a planetary gear assembly according to an embodiment.

FIG. 2 is a view of the planet carrier members of the gear assembly of FIG. 1.

FIG. 3 shows the planet carrier members of FIG. 2 when assembled.

FIG. 4 is a simplified cross section of an elastic connection according to an embodiment of the invention.

FIG. 5 is a scheme of a planetary gear assembly according to another embodiment.

### DETAILED DESCRIPTION OF PREFERRED EMBODIMENTS

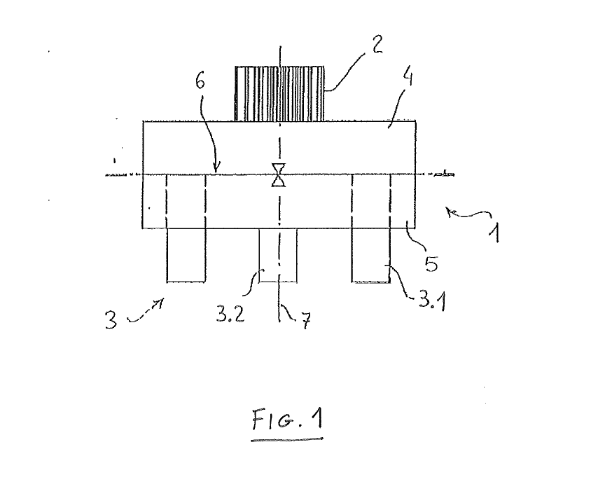

FIG. 1 illustrates a planetary gear assembly comprising a planet carrier 1, a sun gear 2 arranged on a rear side, and a plurality of planet shafts 3 for carrying planet wheels (not shown) on a front side.

The planet carrier 1 comprises a first planet carrier member 4 and a second planet carrier member 5, which in this example are substantially disc-shaped parts separated by a plane 6 perpendicular to a central axis 7 of rotation.

Said planet carries members 4, 5 are rotary displaceable relative to each other around said axis 7, and are elastically connected.

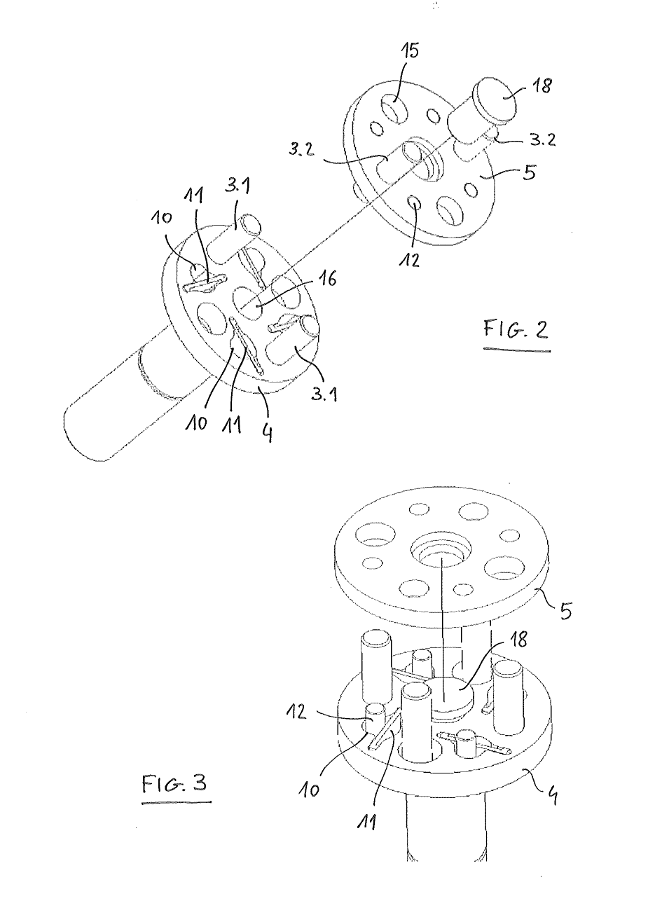

As best seen in FIGS. 2 and 3, the first carrier member 4 comprises a number of seats 10 where flexible blades 11 are fitted. The second carrier member 5 comprises a plurality of pins 12 which protrude from said second member 5, and are received in said seats 10 of the first member 4, when the carrier 1 is assembled. In FIG. 3, the disc portion of member 5 is displaced to show the internals.

Each one of said pins 12 engages a respective blade 11, for example in the shown embodiment the pins 12 abut against the blades 11.

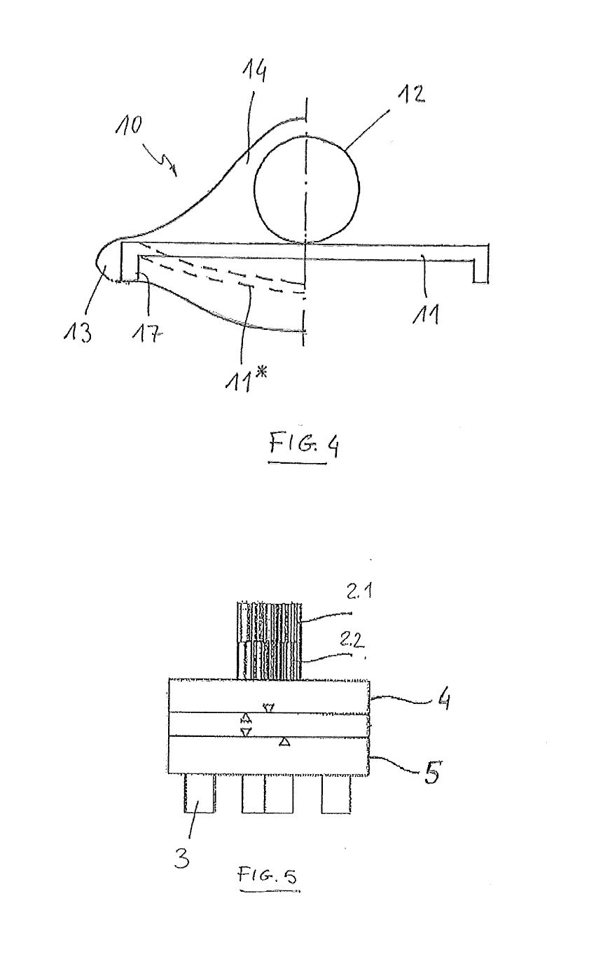

A preferred embodiment is further illustrated in FIG. 4. The seat 10 is substantially a slot with ends 13 configured to receive the opposite ends of the flexible blade 11, and a larger central portion 14 to receive said pin 12 and provide room for deflection of the blade 11. The dotted lines of FIG. 4 show the deflected blade 11*. In the example of the figures, the blade 11 is substantially C-shaped, having supporting portions 17 designed to fit in the ends 13 of the seat 10. It can be seed that the blade 11 acts substantially like a beam under deflection.

In use, the assembly is mounted in such a way that when the carrier members 4, 5 are aligned in the proper working position, the blades 11 are deflected and stores a certain amount of elastic energy, each blade being for example in the condition 11* of FIG. 4. As a consequence, the two members 4, 5 are preloaded. Due to the preload, for example, the teeth of the planet wheels mounted on shafts 3 are urged against the teeth of the annulus (not shown), eliminating the backlash of the device. A backlash that may appear due e.g. to wear of the device, will be automatically eliminated by the system.

In other words, the elastic reaction of the deflected blades 11, pushing the pins 12, tends to rotate the carriers 4, 5 relative to each other, working as a torsional spring and providing a self-recovery of backlash.

The figures show a preferred embodiment where said flexible blade 11 has a constant thickness and a rectangular cross section; different embodiments however are also possible.

The planet carrier 1 of the example is designed to carry four planet wheels. Two first planets are associated to the first carrier member 4, and two second planets are associated to the second carrier member 5. To this purpose, the planetary gear comprises first planet shafts 3.1 which are integral with the first carrier member 4, and second planet shafts 3.2 which are integral with the second carrier member 5. The first shafts 3.1 project from the first planet carrier member 4 and pass through slots 15 of the second planet carrier member 5.

The sun gear 2 is fixed to the first carrier member 4 and may engage the planet wheel of a next (adjoining) stage.

It should be noted that the elastic connections, as shown in the figures, may be arranged leaving a free passage or hole 16 in the centre of the planet carrier 1. In the example, the members 4, 5 are fixed with a fixation pin or screw 18.

FIG. 5 is an example of another embodiment, where the inventive assembly comprises a sun gear which also recovers the backlash, said sun gear having portions rotatable relative to each other and associated to the elastically connected planet carrier members. More in detail, the sun gear 2 now comprises a first axial portion 2.1 and a second axial portion 2.2. The first portion 2.1 is fixed to a planet carrier member and the second portion 2.2 is fixed to another planet carrier member. For example the portions 2.1 and 2.2 may be fixed to the respective carrier members 4, 5 by means of coaxial shafts. Also in this embodiment, the carrier members are elastically connected similarly to FIGS. 2 and 3. FIG. 5 illustrates an embodiment including a further element sandwiched between carrier member 4 and carrier member 5.

1. A planetary gear assembly, comprising a planet carrier (1) including at least a first planet carrier member (4) and a second planet carrier member (5) which are rotatable relative to each other, and also comprising elastic connection means between said first (4) and second (5) planet carrier members, arranged to provide a preload when said planet carrier members (4, 5) are rotationally aligned in a working position,
wherein said elastic connection means include:
at least one elastic member (11) associated to one (4) of said first and second planet carrier members,
a protrusion (12) associated to the other (5) of said first and second planet carrier members, and engaging said elastic member (11),
said elastic member (11) and said protrusion (12) being arranged in such a way that a deflection of said elastic member (11*) provide said preload,
said elastic member (11) being received in a seat (10) of a carrier member (4, 5), and said seat (10) having the shape of a slot with end parts (13) configured to receive opposite ends of said elastic member (11), and a central portion (14) which is larger than said end parts (13) to accommodate said protrusion (12) and provide room for the deflection of said elastic member (11).

2. The planetary gear assembly according to claim 1, wherein said protrusion (12) engages a substantially central portion of said elastic member (11).

3. The planetary gear assembly according to claim 1 wherein said protrusion (12) abuts against said elastic member (11).

4. The planetary gear assembly according to claim 1, said elastic member being a substantially laminar element in the form of a flexible blade (11).

5. The planetary gear assembly according to claim 4, said flexible blade (11) having a constant thickness and a rectangular cross section.

6. The planetary gear assembly according to claim 1, said protrusion being in the form of a pin (12).

7. The planetary gear assembly according to claim 1, said elastic connection means comprising a plurality of elastic members (11), and said elastic members (11) being housed in one or more planet carrier member(s) (4, 5).

8. The planetary gear assembly according to claim 1, further comprising a sun gear (2), said sun gear (2) being split into at least two axial portions (2.1, 2.2) which are rotatable relative to each other, and are fixed to said first carrier member (4) and second carrier member (5) respectively.

9. The planetary gear assembly according to claim 8, said first axial portion (2.1) of the sun gear (2) having a first shaft; said second axial portion (2.2) of the sun gear (2) having a second shaft which is coaxial to the first shaft, said first shaft being connected to said first planet carrier member (4), and said second shaft being connected to said second planet carrier member (5).

10. A gear reducer comprising at least one planetary gear assembly according to any of the previous claims.

11. The gear reducer according to claim 10, the gear reducer being a multi-stage planetary device.

12. The gear reducer of claim 10, the gear reducer being a hybrid device comprising planetary stages and conventional non-epicyclic spur stages.

13. A gear multiplier comprising at least one planetary gear assembly according to any of the previous claims.

14. The gear multiplier of claim 13, the gear multiplier being a multi-stage planetary device.

15. The gear multiplier of claim 13, the gear multiplier being a hybrid device comprising planetary stages and conventional non-epicyclic spur stages.
